(19) United States
(12) Patent Application Publication
(10) Pub. No.: US 2023/0317344 A1
(43) Pub. Date: Oct. 5, 2023

(54) BRACKET FOR HOLDING THE INDUCTOR

(71) Applicant: Eaton Intelligent Power Limited, Dublin 4 (IE)

(72) Inventors: PINGCHANG LIN, Shenzhen (CN); JINDI LIU, Shenzhen (CN); JIAN WEI, Shenzhen (CN)

(21) Appl. No.: 18/191,188

(22) Filed: Mar. 28, 2023

(30) Foreign Application Priority Data
Mar. 29, 2022 (CN) 202220705809.4

(51) Int. Cl. H01F 27/06; H01F 27/26; H01F 27/30

(52) U.S. Cl. CPC H01F 27/06; H01F 27/266; H01F 27/306

(57) ABSTRACT

The present application provides a bracket for holding an inductor, which inductor comprises a toroidal magnetic core including a first axis and a coil including a plurality of wires wound onto the toroidal magnetic core. The bracket comprises a base, a top cover and a coupling means. The base includes a lower base plate and fastening parts, the lower base plate has lower venting passage, and the lower base plate is configurable to attach to an installation surface extending perpendicular to the first axis via the fastening part and fastening means. The top cover includes an upper base plate. At least one upper venting passage is axially opened through the upper base plate. The top cover can be connected to the base by means of the coupling means such that the upper base plat is arranged coaxially with respect to the lower base plate. The axial spacing between the upper base plate and the lower base plate is designed to accommodate the inductor within a space surrounded by the upper base plate, the lower base plate and the coupling means. The bracket with the above configurations could attach the inductor to the installation surface perpendicular to the first axis L.

### TECHNICAL FIELD

The present disclosure relates to the technical field of electrical equipment, in particular to a bracket for holding the inductor.

### BACKGROUND

An uninterruptible power supply (UPS) is a device for providing uninterrupted power supply to power electronic apparatus. An inductor is a key component in an uninterruptible power supply and can be accommodated in the casing of the uninterruptible power supply. The inductor includes a magnetic core and a coil(s), wherein the coil has a plurality of wires wound vertically onto the toroidal magnetic core. In order to install the inductor and avoid the grounding of the inductor, it is necessary to provide a bracket to fix the inductor and insulate it from the ground. Inductors in the prior arts generally can be fixed by two kinds, one kind is to directly weld the inductor on the printed circuit board (PCB), another kind is to hang the inductor on the side of the chassis, for example the configuration disclosed in CN109273206B. In the above two means, the inductor is fixed to the surface to be mounted in such a way that its first axis L is parallel to the surface to be mounted. The prior art is silent in teaching or disclosing a bracket capable of fixing the inductor to the chassis in such a way that its first axis can be perpendicular to the surface to be mounted on the chassis.

### SUMMARY

In order to solve the above problems, the present application provides a bracket, which is configured to include a top cover, a base and a coupling means connecting the top cover to the base coaxially, wherein the inductor will be coaxially arranged with respect to the top cover in a space enclosed by the top cover, the base and the coupling means. The bracket with such configurations could fix the inductor to a surface to be mounted such that the inductor can be perpendicular to the surface to be mounted.

Specifically, the present disclosure provides a bracket for holding an inductor, wherein the inductor comprises a toroidal magnetic core with a first axis and a coil including a plurality of wires wound onto the toroidal magnetic core. The bracket comprises a base, a top cover and a coupling means. The base includes a lower base plate and at least one fastening part attached to the lower base plate, at least one lower venting passage is axially opened through the lower base plate, the lower base plate is configurable to attach to the an installation surface extending perpendicular to the first axis with the fastening part and fastening means. The top cover includes an upper base plate, and at least one upper venting passage is axially opened through the upper base plate. The top cover can be connected to the base by means of the coupling means such that the upper base plat is arranged coaxially with respect to the lower base plate, after the top cover is connected to the base, the axial spacing between the upper base plate and the lower base plate is designed to accommodate the inductor within a space enclosed by the upper base plate, the lower base plate and the coupling means.

The toroidal magnetic core has a first axis L. The bracket with the above configurations could fix the inductor to the surface to be mounted perpendicular to the first axis L.

Preferably, the axial spacing between the upper base plate and the lower base plate is designed to be equal to an axial height of the inductor. Such an arrangement could prevent the inductor from displacing in the axial direction relative to the bracket.

Preferably, the coupling means is configured to include at least three coupling arms, which are designed to be interposed between the two neighboring wires of the core when the inductor is accommodated within the bracket. Such an arrangement could prevent the inductor from rotation relative to the bracket in the circumferential direction.

Preferably, the at least three coupling arms are further designed to abut against the outer circumference surface of the toroidal magnetic core when the inductor is accommodated within the bracket. Such an arrangement could prevent the inductor from displacing in the radial direction relative to the bracket.

Preferably, the coupling arm comprises an upper arm fixed to the upper base plate and a lower arm fixed to the lower base plate, the end of the upper arm being away from the upper base plate and the end of the lower arm being away from the lower base plate can be connected with each other detachably. Such an arrangement could facilitate the disassembly and the assembly of the bracket, and reduce the cost.

Preferably, the base further includes at least three lower supporting parts protruding towards the top cover from the lower base plate, the at least three lower supporting parts are designed to support the axial end of the toroidal magnetic core facing the lower base plate when the inductor is accommodated within the bracket. In this case, the toroidal magnetic core can be directly supported by the lower supporting part, and thus the core could be avoided to be supported by the coil as the prior art, and the supporting stability of the core can be improved.

Preferably, the top cover further includes at least three upper supporting parts protruding towards the base from the upper base plate, the at least three upper supporting parts are designed to abut against the axial end of the toroidal magnetic core facing the upper base plate when the inductor is accommodated within the bracket.

Preferably, both the upper base plate and the lower base plate are designed to be hollow configuration. Such an arrangement can be facilitate in dissipating heat from the inductor with the air blowing from bottom to up.

Preferably, the upper base plate is designed to include a first ring part and a second ring, the diameter of the second ring is greater than that of the first ring part, the first ring part is connected to the second ring by means of first ribs spaced apart to each other along the outer perimeter of the first ring part, wherein the first ring part is provided with a concave stopper extending from the inner perimeter of the first ring part, a notch is provided on the outer perimeter of the second ring, the notch and the concave stopper are positioned and dimensioned to allow the leading-out terminals of the coil to extend therethrough and out of the bracket when the inductor is accommodated within the bracket. Such an arrangement will help to fix the leading-out terminals of the coils.

Preferably, the upper base plate, the lower base plate and the coupling arm are designed to not radially extend beyond the inductor when the inductor is accommodated within the bracket, the fastening part is attached to the outer perimeter of the lower base plate, the fastening part is opened with a mounting hole which is used for allowing the fastening means to pass through. Such an arrangement will be helpful for reducing the materials to be used as well as the take up space of the bracket, which is advantageous for the arrangement of the air channel.

### BRIEF DESCRIPTION OF THE DRAWINGS

Hereinafter, the device of the present application is described in detail in connection with the accompanying drawings, in which

FIG. 1 is a perspective view of the bracket according to the present application, wherein the inductor is accommodated in the bracket, while the base and the top cover are separated from each other;

FIG. 2 is a perspective view of the bracket according to the present application, wherein the inductor is accommodated in the bracket, while the base and the top cover are in an assembled state;

FIG. 3 is a perspective view of the bracket according to the present application, in which the inductor is omitted.

### DESCRIPTION OF THE ACCOMPANYING REFERENCE

1—inductor; 11—toroidal magnetic core; 12—coil; 13—wire; 2—base; 21—lower base plate; 22—lower venting passage; 23—lower supporting part; 24—fastening part; 25—mounting hole; 26—third ring part; 27—fourth ring part; 28—second rib; 3—top cover; 31—upper base plate; 32—upper venting passage; 33—upper supporting part; 34—notch; 35—concave stopper; 36—first ring part; 37—second ring; 38—first rib; 4—coupling means; 41—coupling arm; 42—upper arm; 43—lower arm; L—first axis.

### DETAILED DESCRIPTION OF THE INVENTION

Referring now to the accompanying drawings, the schematic embodiments of the configurations disclosed in the disclosure will be described in detail. Although the drawings are provided to present some embodiments of the disclosure, the drawings need not be drawn to the dimensions of the specific embodiments and certain features may be enlarged, removed or locally cut to better illustrate and explain the disclosure of the disclosure. Certain directional terms used hereinafter to describe the drawings will be understood to have their normal meanings and to refer to those directions involved in a normal view of the accompanying drawings.

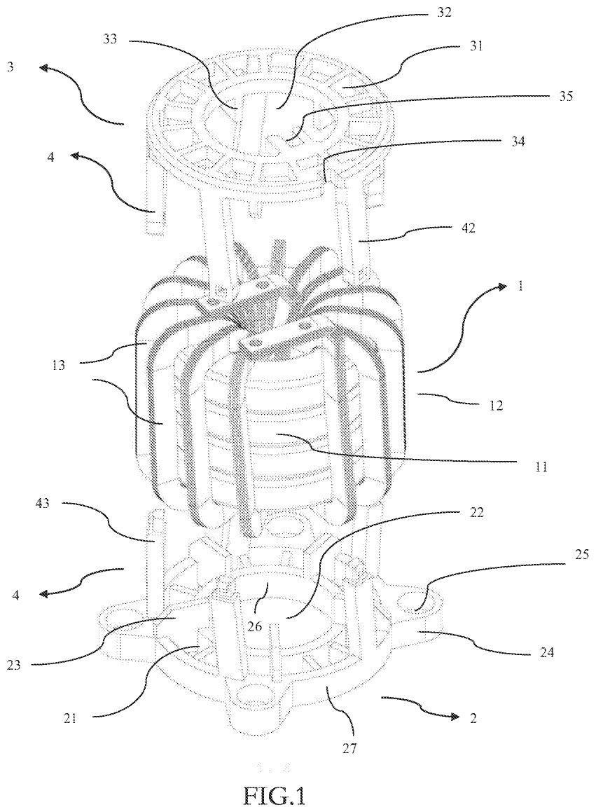

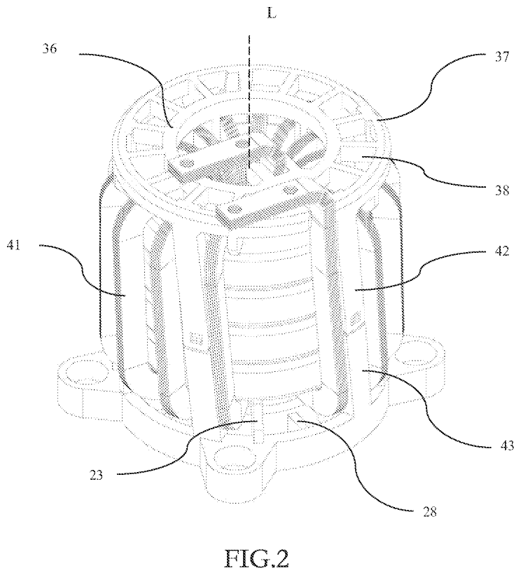

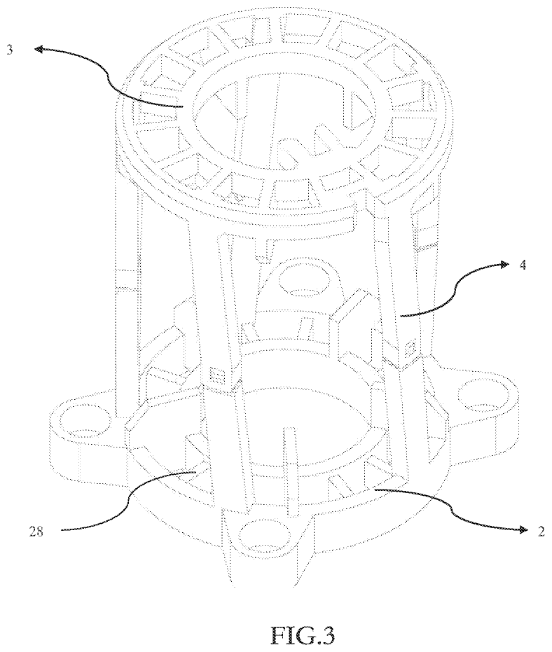

FIGS. 1 and 2 illustrate the schematic views of the configurations of the bracket when the inductor 1 is accommodated within the bracket, respectively, wherein the bracket in FIG. 1 is in a disassembled state and the bracket in FIG. 2 is in an assembled state. At the state shown in FIG. 1, the inductor can be put into or taken away from the bracket. FIG. 3 illustrates the bracket.

Referring to FIGS. 1 and 2, the inductor 1 comprises a toroidal magnetic core 11 and a coil 12. Although only one coil is shown as an example in the drawings, the skilled in the art will understand that the inductor can comprises more than one coils. The toroidal magnetic core 11 has a first axis L, and the coil 12 has several wires 13 which can be wounded onto the toroidal magnetic core 11. The specific configuration of the inductor 1 is known in the prior art and thus will be not repeated here.

Continue referring to FIG. 3, the bracket is configured to include a base 2, a top cover 3 and a coupling means 4 for connecting the top cover 3 to the base 2. The inductor 1 will be accommodated within a space surrounded by the base 2, the top cover 3 and coupling means 4, and the whole inductor 1 will be supported by the base 2.

Specifically, the top cover 3 has an upper base plate 31 through which at least one upper venting passage 32 is opened in the axial direction. Preferably, the upper base plate 31 is designed to be a hollow configuration, i.e. has at least two, preferably more upper venting passage. As the configuration shown in the drawings, the upper base plate 31 is substantially annular and comprises a first ring part 36 with a first diameter and a second ring 37 with a second diameter greater than the first diameter. The first ring part 36 and the second ring part 37 are connected together by means of several first ribs 38 extending in the radial direction. Several first ribs 38 are spaced apart from each other along an outer circumstance of the first ring part 36.

The base 2 is configured to include a lower base plate 21 and at least one fastening part 24. At least one lower venting passage 22 is opened through the lower base plate 21 in the axial direction, such that the air could access the hollow core of the inductor 1 from the bottom of the inductor. Similarly, it is preferable for the lower base plate 21 to be designed in a hollow configuration, i.e. has at least two, preferably more lower venting passages. As the configuration shown in the drawings, the lower base plate 21 is substantially annular and comprises a third ring part 26 with a third diameter and a fourth ring part 27 with a fourth diameter greater than the third diameter. The third ring part 26 and the fourth ring part 27 are connected with each other by means of a plurality of second ribs 28 extending in the radial direction. The plurality of second ribs 28 are spaced apart from each other along an outer circumstance of the third ring part 26.

The upper base plate 31 and the lower base plate 21 with the above configurations could maximum the venting area while ensuring the constructive strength.

When the inductor 1 is accommodated within the bracket, the upper venting passage 32, the hollow core of the inductor 1 and the lower venting passage 22 will allow the air flow through, such that the air could access the inductor 1 from the bottom/top of the inductor 1, pass through the inductor 1 and then leave the inductor 1 from the top/bottom of the inductor 1, which facilitates in dissipating heat from the inductor 1. When the total venting area of the upper venting passage 32 and the total venting area of the lower venting passage 22 become larger, more air will flow through the inductor 1 and the heat dissipation effect can be better.

The bracket according to the present disclosure further includes a coupling means 4, by means of which the top cover 3 can be connected to the base 2. Wherein, after the top cover 3 is connected to the base 2, the upper base plate 31 can be arranged coaxially with the lower base plate 21. The axial spacing between the upper base plate 31 and the lower base plate 21 is designed to accommodate the inductor 1 within the inner space surrounded by the upper base plate 31, the lower base plate 21 and the coupling means 4. In the case that the axial spacing between the upper base plate 31 and the lower base plate 21 is equal to the axial height of the inductor 1, the upper base plate 31 and the lower base plate 21 could prevent the inductor 1 from displacing in the axial direction.

The coupling means 4 includes at least three coupling arms 41, and the present disclosure has disclosed five coupling arms 41. Each of the coupling arms 41 comprises an upper arm 42 and a lower arm 43. Wherein the upper arm 42 can be attached to the upper base plate 31, and the lower arm 43 can be attached to the lower base plate 21. An end of the upper arm 42 being away from the upper base plate 31 and an end of the lower arm 43 being away from the lower base plate 21 can be designed to be connected together in a detachable manner, for example by means of snap fit, magnetic connection and fastener coupling et al. Such a detachable connection between the upper arm 42 and the lower arm 43 will facilitate in assembling and disassembling the bracket.

In particular referring to FIG. 2, the coupling arm 41 can be interposed between the two neighboring wires 13 of the core 12 when the inductor 1 is accommodated within the bracket, such that the inductor 1 can be prevented from rotating in the circumference direction. The coupling arm 41 is further designed to abut against an outer circumference surface of the toroidal magnetic core 11 when the inductor 1 is accommodated within the bracket, such that the inductor 1 can be prevented from displacing along its radial direction.

The base 2 further includes at least three lower supporting parts 23 protruding towards the top cover 3 from the lower base plate 21, the present application has disclosed five lower supporting parts 23. When the inductor 1 is arranged within the bracket, the lower supporting part 23 will support an axial end of the toroidal magnetic core 11 facing the lower base plate 21, whereby the core can be supported by the lower supporting parts 23. In this way, the core could be avoided to be directly supported by the coil 12 as the prior art.

The top cover 3 further comprises at least three upper supporting parts 33 protruding towards the base 2 from the upper base plate 31. Preferably, the number of the upper supporting parts 33 is equal to the number of the lower supporting part 23. The upper supporting part 33 is designed to abut against the axial end of the toroidal magnetic core 11 facing the upper base plate 31 when the inductor 1 is accommodated within the bracket.

Such a solution could reduce the load applied on the coil 12 and prolong the service life of the coil 12. Meanwhile, the core can be supported in a more stable manner, and can be prevented from moving undesirably with respect to the bracket due to the factors such as the deformation of the coil 12 during the use.

The lower base plate 21 could be fixedly mounted to an installation surface extending perpendicular to the first axis L by means of the fastening parts 24 and fastening means, for example screw. The fastening part 24 can be a separate component attached to the outer perimeter of the lower base plate 21 for example by the way of glue bonding or welding et al. The fastening part 24 can also be a part protruding from the outer perimeter of the lower base plate 21, namely the fastening part 24 and the lower base plate 21 can be formed as one piece member. Preferably, at least three (four applied in this text) fastening part 24 can be provided, wherein the fastening part 24 can be provided with a mounting hole 25 through which the fastening mean could pass. It will be understood by the skilled in the art that the configuration of the fastening part is not only limited to the above forms, for example it is not necessary for the fastening part to be arranged in the same plane with the lower base plate 21. Other possible arrangements that could fix the lower base plate 21 to the installation surface extending perpendicular to the first axis L also fall into the scope of the present application.

The upper base plate 31, the lower base plate 21 and the coupling means 4 can be designed to not radially extend beyond the inductor 1 when the indictor 1 is accommodated within the bracket. In the present text, the radial dimensions of the upper base plate 31 and the lower base plate 21 are equal to that of the inductor 1. The radial dimension of the coupling arm is also not larger than the inductor, for example the coupling arm could be extended perpendicular to the upper base plate 31 and the lower base plate 21. In the bracket with the above configuration, other components of the bracket, except for the fastening part 24, do not extend beyond the outer diameter of the inductor 1, such that the materials to be used as well as the take up space of the bracket can be minimized, which is advantageous for the arrangement of the air channel.

Furthermore, the outer perimeter of the second ring 37 can be provided with a notch(s) 34, and the first ring part 36 can be provided with a concave stopper(s) 35 extending from the inner perimeter of the first ring part. When the inductor 1 is accommodated within the bracket, the notch 34 and the concave stopper 35 can be used for allowing the leading-out terminals of the coil 12 to extend therethrough and out of the bracket, so to advantageously fix the leading-out terminals to prevent them from moving freely. Each of the coils has two leading-out terminals, i.e. a starting terminal and an ending terminal. In the case that the inductor only includes one coil, as shown in FIG. 2, one of the two leading-out terminals of the coil could pass through the notch and another could pass through the concave stopper. In the case that the inductor has more coils, the leading-out terminals of the coil could be optionally inserted into the notch or the concave stopper depending on their final protruding positions so as to facilitate their fixing.

1. A bracket for holding an inductor comprising a toroidal magnetic core and a coil wound onto the toroidal magnetic core, the bracket comprising:
a base including a base plate with at least one lower venting passage therethrough and configured to attach to an installation surface and at least one first member extending from the base plate; and
a top cover including an upper plate with at least one upper venting passage therethrough and at least one second member extending from the upper plate and configured to be joined with the at least one first member to contain the inductor in a space defined by the base plate, the upper plate, the at least one first member and the at least one second member.

2. (canceled)

3. The bracket according to claim 1, wherein the at least one first member and the at least one second member each comprise at least three coupling arms configured to be positioned between neighboring wires of the coil when the inductor is accommodated within the bracket.

4. The bracket according to claim 3, wherein the coupling arms abut the toroidal magnetic core when the inductor is accommodated within the bracket.

5. The bracket according to claim 3, wherein the coupling arms of the base and top cover detachably connect to one another.

6. The bracket according to claim 1, wherein the base further includes at least three lower supporting parts protruding towards the top cover from the base plate and configured to abut a first end of the toroidal magnetic core facing the base plate when the inductor is accommodated within the bracket.

7. The bracket according to claim 6, wherein the top cover further includes at least three upper supporting parts protruding towards the base from the upper plate and configured to abut a second end of the toroidal magnetic core facing the upper plate when the inductor is accommodated within the bracket.

8. (canceled)

9. The bracket according to claim 1, wherein the upper plate includes a first ring part and a second ring part with a diameter greater than that of the first ring part, wherein the first ring part is connected to the second ring via ribs spaced apart along an outer wall of the first ring part, wherein a stopper extends from an inner wall of the first ring part, wherein a notch is provided on an outer wall of the second ring part, and wherein the notch and the stopper are configured to receive leading-out terminals of the coil when the inductor is accommodated within the bracket.

10. The bracket according to claim 1, wherein the base plate is provided with a mounting hole for receiving a fastener for attachment of the base plate to the installation surface.

11. An apparatus comprising:
a bracket comprising:
a base plate;
a first plurality of coupling arms extending from the base plate;
an upper plate; and
a second plurality of coupling arms extending from the upper plate, wherein ends of the first and second pluralities of coupling arms are attached to one another; and
an inductor disposed in a space defined by the base plate, the upper plate and the first and second pluralities of coupling arms.

12. The apparatus of claim 11, wherein the inductor comprises:
a toroidal magnetic core; and
a coil wound onto the toroidal magnetic core.

13. The apparatus of claim 12, wherein first and second ends of the toroidal magnetic core face respective ones of the base plate and the upper plate and wherein the first and second pluralities of coupling arms are disposed adjacent sides of the toroidal magnetic core.

14. The apparatus of claim 13, wherein the coupling arms of the first and second pluralities of coupling arms extend between neighboring wires of the coil.

15. The apparatus of claim 14, wherein the coupling arms of the first and second pluralities of coupling arms abut the toroidal magnetic core.

16. The apparatus of claim 12, wherein the coupling arms of the first and second pluralities of coupling arms detachably connect to one another.

17. The apparatus of claim 12, wherein the upper plate comprises a first ring part and a second ring part with a diameter greater than that of the first ring part, wherein the first ring part is connected to the second ring part via ribs spaced apart along an outer wall of the first ring part, wherein a stopper extends from an inner wall of the first ring part, wherein a notch is provided on an outer wall of the second ring part, and wherein the notch and the stopper are receive leading-out terminals of the coil.

18. The apparatus of claim 11, wherein the base plate is provided with a mounting hole for receiving a fastener for attachment of the base plate to a surface.
